(19) United States
(12) Patent Application Publication
(10) Pub. No.: US 2021/0383311 A1
(43) Pub. Date: Dec. 9, 2021

(54) METHODS AND APPARATUS FOR MARKETPLACE ITEM UPDATES

(71) Applicant: Walmart Apollo, LLC, Bentonville, AR (US)

(72) Inventors: Wayne Hong, Santa Rosa, CA (US); Bharat Ambalal Patel, San Ramon, CA (US); Anthony James Kitchin, Oakland, CA (US)

(21) Appl. No.: 16/895,731

(22) Filed: Jun. 8, 2020

(51) Int. Cl. G06Q 10/08; G06Q 30/06; G06N 20/00; G06F 40/295

(52) U.S. Cl. CPC G06Q 10/087; G06F 40/295; G06N 20/00; G06Q 30/0623

(57) ABSTRACT

This application relates to apparatus and methods for automatically providing item information updates to websites such as online marketplaces. In some examples, a computing device receives item update information from one or more retailers that sell items on the websites. The computing device determines differences between the item information updates and current item information. In some examples, the computing device determines the differences based on execution of one or more models, such as a neural network or machine learning model. The computing device then generates messages particular to each of the websites based on the determined differences. For example, the computing device generates a message to each website in accordance with a protocol supported by each website. The computing device then transmits the messages to each of the websites. In some examples, the computing device maintains a status of each update, and may display such status.

### TECHNICAL FIELD

The disclosure relates generally to online marketplace systems and, more specifically, to providing content for online marketplace systems.

### BACKGROUND

Retailers, in at least some examples, sell items, such as products or services, online, such as on websites (e.g., online marketplaces). For example, a retailer may advertise a item on an online marketplace, where a customer can view the item and proceed to purchase the item. In some examples, retailers may offer the item for sale on multiple websites. For example, the retailer may offer the item for sale on various online marketplaces. As such, an online marketplace may offer for sale items from multiple retailers.

To advertise and provide for sale an item, a retailer may provide the online marketplace with information (e.g., attributes) about the item for the item to be listed (e.g., provided for sale) on the online marketplace (e.g., an item listing). For example, the retailer may provide to the online marketplace one or more of an image of the item, a price for the item, an item description, and options for the item. The retailer may also manage item listings on the online marketplace, such as by editing any of the information for an item, adding new item listings, and removing existing item listings.

The management of item listings on websites, such as on online marketplaces, presents challenges. For example, there are incentives for retailers and operators of websites to ensure that the item listings are accurate. For example, unnecessary time and effort would be expended to correct item prices for items sold for an incorrect price, or for items sold for items that are no longer available. As such, there are opportunities to improve address the maintenance of item listings on websites, such as on online marketplaces.

### SUMMARY

The embodiments described herein are directed to automatically detecting item listing information changes and, in response, taking one or more actions to reflect the changes on one or more websites, such as on an online marketplace. The item listing information changes may be provided by retailers, such as third-parties advertising or selling an item on the online marketplace. The embodiments may also provide a collector of item listing changes, where retailers can provide the item listing changes via interfaces (e.g., application programming interfaces (APIs). Further, the embodiments may include catalog data for items, where the catalog data includes information about each item. The embodiments may detect changes to catalog data based on the received item listing changes from the retailers, and update one or more websites via respective interfaces to each website.

As such, the embodiments improve the accuracy of item listing information on websites. The embodiments may further reduce the time, cost, and effort required to maintaining item listings across one or more websites. In addition to or instead of these example advantages, persons of ordinary skill in the art would recognize and appreciate other advantages as well.

In accordance with various embodiments, exemplary systems may be implemented in any suitable hardware or hardware and software, such as in any suitable computing device. In some embodiments, a computing device receives item update information from one or more retailers that sell items on the websites. The computing device also determines differences between the item information updates and current item information. In some examples, the computing device determines the differences based on execution of one or more models, such as a neural network or machine learning model. The computing device then generates messages particular to each of the websites based on the determined differences. For example, the computing device generates a message to each website in accordance with a protocol supported by each website. The computing device then transmits the messages to each of the websites. In some examples, the computing device maintains a status of each update, and may display such status.

In some embodiments, a computing device is configured to receive item update data identifying at least one attribute of an item. The computing device is also configured to determine at least one difference to a current item listing of the item based on the item update data. For example, the computing device may determine the at least on difference based on detecting textual differences between the item update data and item data for the item stored in a database. The computing device is further configured to generate marketplace data for at least one marketplace based on the at least one difference. The computing device is also configured to transmit the marketplace data to update the at least one marketplace. For example, the computing device may transmit the marketplace data to a web server hosting the at least one marketplace.

In some embodiments, a method is provided that includes receiving item update data identifying at least one attribute of an item. The method also includes determining at least one difference to a current item listing of the item based on the item update data. For example, the method may include determining the at least on difference based on detecting textual differences between the item update data and item data for the item stored in a database. The method further includes generating marketplace data for at least one marketplace based on the at least one difference. The method also includes transmitting the marketplace data to update the at least one marketplace. For example, the method may include transmitting the marketplace data to a web server hosting the at least one marketplace.

In yet other embodiments, a non-transitory computer readable medium has instructions stored thereon, where the instructions, when executed by at least one processor, cause a computing device to perform operations that include receiving item update data identifying at least one attribute of an item. The operations also include determining at least one difference to a current item listing of the item based on the item update data. For example, the operations may include determining the at least on difference based on detecting textual differences between the item update data and item data for the item stored in a database. The operations further include generating marketplace data for at least one marketplace based on the at least one difference. The operations also include transmitting the marketplace data to update the at least one marketplace. For example, the operations may include transmitting the marketplace data to a web server hosting the at least one marketplace.

### BRIEF DESCRIPTION OF THE DRAWINGS

The features and advantages of the present disclosures will be more fully disclosed in, or rendered obvious by the following detailed descriptions of example embodiments. The detailed descriptions of the example embodiments are to be considered together with the accompanying drawings wherein like numbers refer to like parts and further wherein:

FIG. 1 is a block diagram of an item information facilitator system in accordance with some embodiments;

FIG. 2 is a block diagram of an item information facilitator computing device of the item information facilitator system FIG. 1 in accordance with some embodiments;

FIG. 3 is a block diagram illustrating examples of various portions of the item information facilitator system of FIG. 1 in accordance with some embodiments;

FIG. 4 is a block diagram illustrating examples of providing item listings to an online marketplace via an interface in accordance with some embodiments;

FIG. 5 is a flowchart of an example method that can be carried out by the item information facilitator computing device of FIG. 1 in accordance with some embodiments; and

FIG. 6 is a flowchart of another example method that can be carried out by the item information facilitator computing device of FIG. 1 in accordance with some embodiments.

### DETAILED DESCRIPTION

The description of the preferred embodiments is intended to be read in connection with the accompanying drawings, which are to be considered part of the entire written description of these disclosures. While the present disclosure is susceptible to various modifications and alternative forms, specific embodiments are shown by way of example in the drawings and will be described in detail herein. The objectives and advantages of the claimed subject matter will become more apparent from the following detailed description of these exemplary embodiments in connection with the accompanying drawings.

It should be understood, however, that the present disclosure is not intended to be limited to the particular forms disclosed. Rather, the present disclosure covers all modifications, equivalents, and alternatives that fall within the spirit and scope of these exemplary embodiments. The terms “couple,” “coupled,” “operatively coupled,” “operatively connected,” and the like should be broadly understood to refer to connecting devices or components together either mechanically, electrically, wired, wirelessly, or otherwise, such that the connection allows the pertinent devices or components to operate (e.g., communicate) with each other as intended by virtue of that relationship.

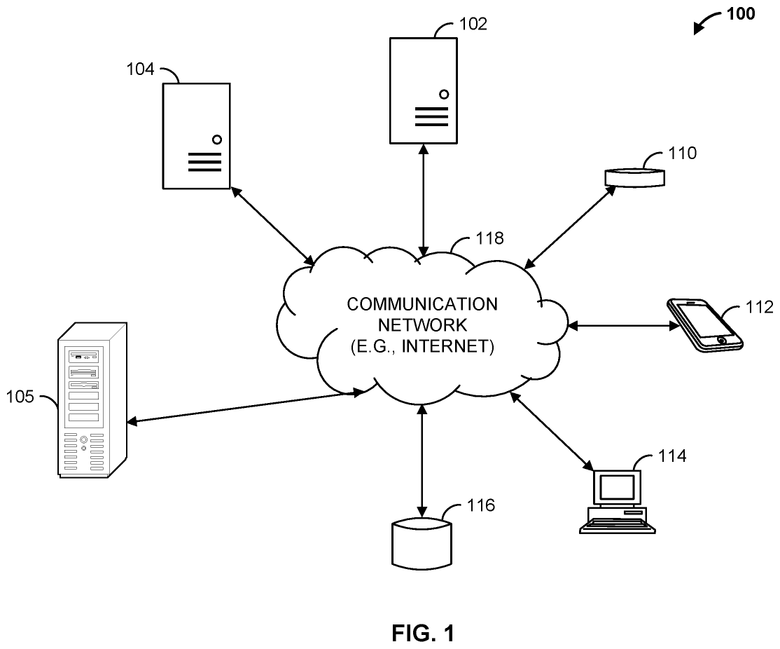

Turning to the drawings, FIG. 1 illustrates a block diagram of an item information facilitator system 100 that includes an item information facilitator computing device 102 (e.g., a server, such as an application server), a web server 104, database 116, an item data update system 105, and multiple customer computing devices 110, 112, 114 operatively coupled over network 118. Item information facilitator computing device 102, server 104, item data update system 105, and multiple customer computing devices 110, 112, 114 can each be any suitable computing device that includes any hardware or hardware and software combination for processing and handling information. For example, each can include one or more processors, one or more field-programmable gate arrays (FPGAs), one or more application-specific integrated circuits (ASICs), one or more state machines, digital circuitry, or any other suitable circuitry. In addition, each can transmit data to, and receive data from, communication network 118.

In some examples, each of item information facilitator computing device 102 and item data update system 105 can be a computer, a workstation, a laptop, a server such as a cloud-based server, or any other suitable device. In some examples, each of multiple customer computing devices 110, 112, 114 can be a cellular phone, a smart phone, a tablet, a personal assistant device, a voice assistant device, a digital assistant, a laptop, a computer, or any other suitable device. In some examples, item information facilitator computing device 102 is operated by a retailer, and multiple customer computing devices 112, 114 are operated by customers of the retailer.

Although FIG. 1 illustrates three customer computing devices 110, 112, 114, item information facilitator system 100 can include any number of customer computing devices 110, 112, 114. Similarly, item information facilitator system 100 can include any number of item information facilitator computing devices 102, web servers 104, item data update systems 105, and databases 116.

In some examples, web server 104 hosts one or more web pages, such as a retailer's website. For example, web server 104 may host an online marketplace where customers may view and purchase items. The online marketplace may list items from a variety of retailers, such as third-party item listings. Customers may, via customer computing devices 110, 112, 114 communicating with web server 104 over communication network 118, visit the online marketplace and view the item listings. Customers may also purchase the listed items via the online marketplace. For example, the online marketplace may provide an “add-to-cart” that, when engaged (e.g., clicked on) by the customer, facilitates the placement of items into an online shopping cart. The online marketplace may further provide a “checkout” icon that facilitates the purchase of the items in the online shopping cart.

In at least some examples, item information facilitator computing devices 102 provides item listings (e.g., item listing changes or updates) to one or more online marketplaces, such as the online marketplace hosted by web server 104. For example, item information facilitator computing devices 102 may provide an interface (e.g., APIs) to retailers that allow each retailer to manage (e.g., update, add, remove, etc.) item information for each of one or more items. The retailer may access the interfaces via an item data update system 105. Item information facilitator computing device 102 may parse the item listings received via the interfaces to extract item listing data, generate a message that includes the item listing data, and place the message onto a message queue for further processing as discussed further herein. For example, item information facilitator computing device 102 may determine, based on each message, whether an item listing for any of a plurality of online marketplaces requires an update. If any item listing requires an update, item information facilitator computing device 102 may update the one or more online marketplaces via respective interfaces (e.g., APIs) with item listing updates. The online marketplaces may then display the updated item listing updates or, in the example of the removal of an item listing, may remove the item listing from the online marketplace.

Item information facilitator computing device 102 is further operable to communicate with database 116 over communication network 118. For example, item information facilitator computing device 102 can store data to, and read data from, database 116. Database 116 can be a remote storage device, such as a cloud-based server, a disk (e.g., a hard disk), a memory device on another application server, a networked computer, or any other suitable remote storage. Although shown remote to item information facilitator computing device 102, in some examples, database 116 can be a local storage device, such as a hard drive, a non-volatile memory, or a USB stick. Item information facilitator computing device 102 may store item listing data received from item data update system 105 in database 116. For example, item information facilitator computing device 102 may aggregate item listing data for a plurality of items, such as items sold across a plurality of online marketplaces, in database 116. Upon receiving an item listing from item data update system 105, item information facilitator computing device 102 may compare the extracted item listing data to the item listing data stored in database 116 to determine if any item listing information has changed.

Communication network 118 can be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. Communication network 118 can provide access to, for example, the Internet.

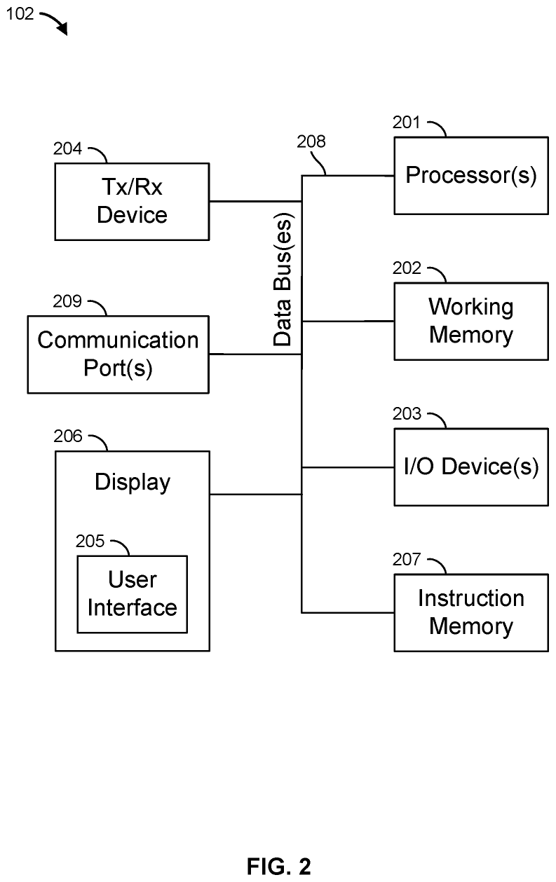

FIG. 2 illustrates the item information facilitator computing device 102 of FIG. 1. Item information facilitator computing device 102 can include one or more processors 201, working memory 202, one or more input/output devices 203, instruction memory 207, a transceiver 204, one or more communication ports 207, and a display 206, all operatively coupled to one or more data buses 208. Data buses 208 allow for communication among the various devices. Data buses 208 can include wired, or wireless, communication channels.

Processors 201 can include one or more distinct processors, each having one or more cores. Each of the distinct processors can have the same or different structure. Processors 201 can include one or more central processing units (CPUs), one or more graphics processing units (GPUs), application specific integrated circuits (ASICs), digital signal processors (DSPs), and the like.

Instruction memory 207 can store instructions that can be accessed (e.g., read) and executed by processors 201. For example, instruction memory 207 can be a non-transitory, computer-readable storage medium such as a read-only memory (ROM), an electrically erasable programmable read-only memory (EEPROM), flash memory, a removable disk, CD-ROM, any non-volatile memory, or any other suitable memory. Processors 201 can be configured to perform a certain function or operation by executing code, stored on instruction memory 207, embodying the function or operation. For example, processors 201 can be configured to execute code stored in instruction memory 207 to perform one or more of any function, method, or operation disclosed herein.

Additionally processors 201 can store data to, and read data from, working memory 202. For example, processors 201 can store a working set of instructions to working memory 202, such as instructions loaded from instruction memory 207. Processors 201 can also use working memory 202 to store dynamic data created during the operation of item information facilitator computing device 102. Working memory 202 can be a random access memory (RAM) such as a static random access memory (SRAM) or dynamic random access memory (DRAM), or any other suitable memory.

Input-output devices 203 can include any suitable device that allows for data input or output. For example, input-output devices 203 can include one or more of a keyboard, a touchpad, a mouse, a stylus, a touchscreen, a physical button, a speaker, a microphone, or any other suitable input or output device.

Communication port(s) 209 can include, for example, a serial port such as a universal asynchronous receiver/transmitter (UART) connection, a Universal Serial Bus (USB) connection, or any other suitable communication port or connection. In some examples, communication port(s) 209 allows for the programming of executable instructions in instruction memory 207. In some examples, communication port(s) 209 allow for the transfer (e.g., uploading or downloading) of data, such as item listing data.

Display 206 can display user interface 205. User interfaces 205 can enable user interaction with item information facilitator computing device 102. For example, user interface 205 can be a user interface for an application of a retailer that allows a customer to view and interact with a retailer's website. In some examples, a user can interact with user interface 205 by engaging input-output devices 203. In some examples, display 206 can be a touchscreen, where user interface 205 is displayed on the touchscreen.

Transceiver 204 allows for communication with a network, such as the communication network 118 of FIG. 1. For example, if communication network 118 of FIG. 1 is a cellular network, transceiver 204 is configured to allow communications with the cellular network. In some examples, transceiver 204 is selected based on the type of communication network 118 item information facilitator computing device 102 will be operating in. Processor(s) 201 is operable to receive data from, or send data to, a network, such as communication network 118 of FIG. 1, via transceiver 204.

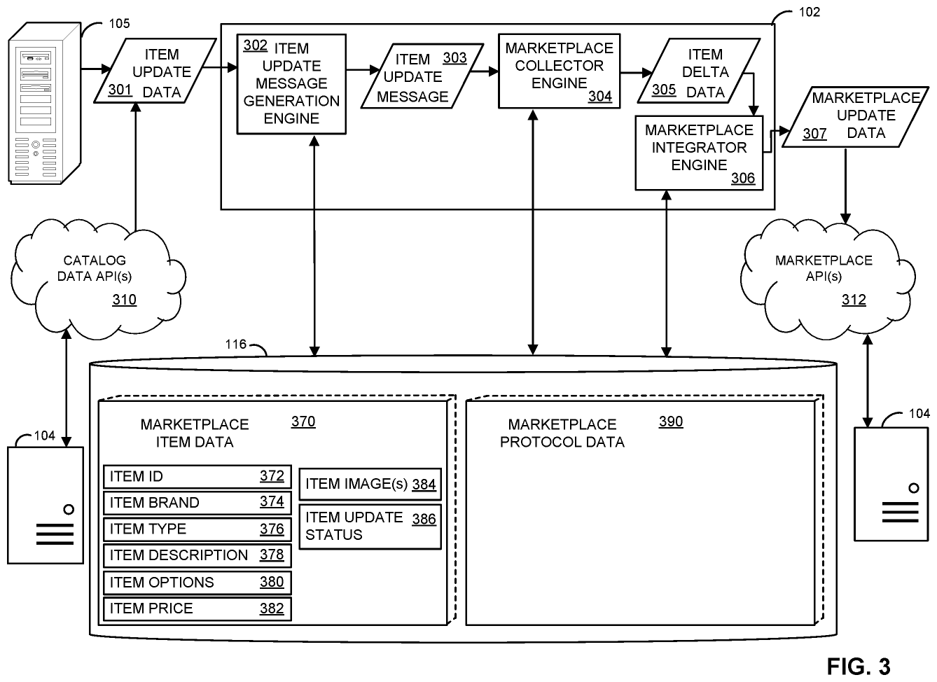

FIG. 3 is a block diagram illustrating examples of various portions of the item information facilitator system 100 of FIG. 1. As indicated in the figure, item information facilitator computing device 102 may receive item update data 301 from item data update system 105. Item update data 301 may include, for example, item listings identifying item listing information for one or more items, such as items sold on an online marketplace. In some examples, item update data 301 may include a request for new item listings (e.g., item listings for items not yet available on the online marketplace), or a request for the removal of item listings. In some examples, item update data 301 may include one or more of an item ID, an item description, an item price, item options, item availability, or any other data related to an item. In some examples, item data update system 105 provides item update data 301 only when changing item listing data for one or more items.

Item information facilitator computing device 102 may also obtain item update data 301 via catalog data APIs 310 maintained by one or more web servers 104. For example, a retailer may maintain item update data 301 (e.g., item information) related to a plurality of items in a database. The retailer may make the item update data 301 available via catalog data APIs 310. Item information facilitator computing device 102 may occasionally (e.g., periodically, hourly, nightly, weekly, monthly, etc.) submit a request to catalog data APIs 310 to obtain the item update data 301 and, in response to the request, web server 104 may provide the item update data 301.

As indicated in FIG. 3, item information facilitator computing device 102 includes item update message generation engine 302, marketplace collector engine 304, and marketplace integrator engine 306. In some examples, one or more of item update message generation engine 302, marketplace collector engine 304, and marketplace integrator engine 306 may be implemented in hardware. In some examples, one or more of item update message generation engine 302, marketplace collector engine 304, and marketplace integrator engine 306 may be implemented as an executable program maintained in a tangible, non-transitory memory, such as instruction memory 207 of FIG. 2, that may be executed by one or processors, such as processor 201 of FIG. 2.

Item update message generation engine 302 receives item update data 301, and parses item update data 301 to extract item listing data from item update data 301. In some examples, item update message generation engine 302 associates a portion of the extracted item listing data with a corresponding category, such as an item ID, an item description, or an item price. In some examples, item update data 301 identifies and characterizes the corresponding fields. Item update message generation engine 302 may then determine if an update to an item listing is warranted (e.g., required). For example, item update message generation engine 302 may compare the extracted item listing data to marketplace item data 370 that reflects item listings as currently provided on one or more online marketplaces. Marketplace item data 370 may be maintained in a database, such as database 116, and may include item data related to item listings available on each of a plurality of online marketplaces. For example, database 116 may maintain marketplace item data 370 for each of a plurality of online marketplaces.

Marketplace item data 370 may include, for each item listing, one or more attributes of each item. For example, marketplace item data 370 may include an item ID 372 (e.g., an SKU number), an item brand 374, an item type 376 (e.g., grocery item such as milk, clothing item), an item description 378 (e.g., a description of the item such as item features), item options 380 (e.g., item colors, sizes, flavors, etc.), an item price 382, and an item image(s) 384 (e.g., an image of the item displayed on the online marketplace, such as for advertising the item).

Item update message generation engine 302 may determine whether there is a difference between item listing data extracted from item update data 301 and marketplace item data 370 for the corresponding item. For example, item update message generation engine 302 may perform a text-based comparison between corresponding categories of the extracted item data and the marketplace item data 370 for the corresponding item. Item update message generation engine 302 may execute a model, such as a neural network or machine learning model, to execute the text-based comparison. For example, item update message generation engine 302 may execute a Word2vec model to generate word embeddings for the extracted item data and the marketplace item data 370 for the corresponding item, and may then compare the generated word embeddings to determine any differences.

If item update message generation engine 302 determines there is a difference (e.g., and thus an update required), item update message generation engine 302 may generate an item update message 303 identifying and characterizing the difference in the item listing. In some examples, item update message 303 identifies the addition of a new item listing, or the removal (e.g., deletion) of an existing item listing. Item update message generation engine 302 may provide the item update message 303 to marketplace collector engine 304. For example, item update message generation engine 302 may place the item update message 303 on an item update message queue. Marketplace collector engine 304 may then obtain the item update message 303 from the item update message queue. For example, marketplace collector engine 304 may be a subscriber to the item update message queue and, in some examples, may poll the item update message queue to determine whether item update message queue currently holds any item update messages 303. If item update message queue has any item update messages 303, marketplace collector engine 304 may obtain and remove (e.g., de-queue) the item update messages 303 from the item update message queue.

Marketplace collector engine 304 may determine one or more online marketplaces to provide the determined differences (e.g., changes) to, and may provide the differences marketplace integrator engine 306. For example, marketplace collector engine 304 may determine which, out of a plurality of marketplace item data 370 corresponding to each of a plurality of online marketplaces, provides item listings for the item corresponding to item update message 303. The determinations may be made based on, for example, an item ID 372. Specifically, item update message 303 may identify an item ID 372 of the corresponding item. Marketplace collector engine 304 may determine the online marketplaces that include item listings for the item based on item ID 372 of the marketplace item data 370 for each online marketplace. If marketplace collector engine 304 determines that an online marketplace includes the item listing, marketplace collector engine 304 may generate item delta data 305 identifying and characterizing the item listing differences. Marketplace collector engine 304 may then provide item delta data 305 to marketplace integrator engine 306. In response to obtaining item delta data 305, marketplace collector engine 304 may generate item delta data 305 for each online marketplace requiring a change to the item listing. For example, marketplace collector engine 304 may include in item delta data 305 a marketplace ID identifying each online marketplace needing an update. In this manner, item information facilitator computing device 102 can facilitate the updating of a plurality of online marketplaces with the updates identified in item delta data 305.

In some examples, item delta data 305 includes an item delta message. Marketplace collector engine 304 may place the item delta message on an item delta message queue that is also accessible by marketplace integrator engine 306. For example, marketplace integrator engine 306 may be a subscriber to the item delta message queue and, in some examples, may poll the item delta message queue periodically (e.g., every 15 minutes, every hour, nightly, weekly, etc.) to determine whether there are any item delta messages.

Marketplace integrator engine 306 obtains item delta data 305 from marketplace collector engine 304, and updates a corresponding item listing on the corresponding online marketplace based on the differences identified in item delta data 305. For example, marketplace integrator engine 306 generates marketplace update data 307 based on a protocol corresponding to a marketplace API 312 associated with each online marketplace. A configuration for each online marketplace identifying requirements for each protocol may be maintained in a database, such as marketplace protocol data 390 stored in database 116.

For example, assume item delta data 305 identifies changes to an item description 378 for an item identified by an item ID 372 for a particular online marketplace. Further, assume that the marketplace API 312 for an online marketplace requires (e.g., as determined based on protocol requirements identified by marketplace protocol data 390 stored in database 116) that the entire item description, rather than just the differences, be provided to update the item description of the item on the online marketplace. Marketplace integrator engine 306 may obtain the current item description 378 for the item from database 116, and may generate an updated item description by updating the current item description 378 with the changes identified by item delta data 305. Marketplace integrator engine 306 may then generate marketplace update data 307 identifying the updated item description, and transmit marketplace update data 307 to the web server 104 hosting the corresponding online marketplace.

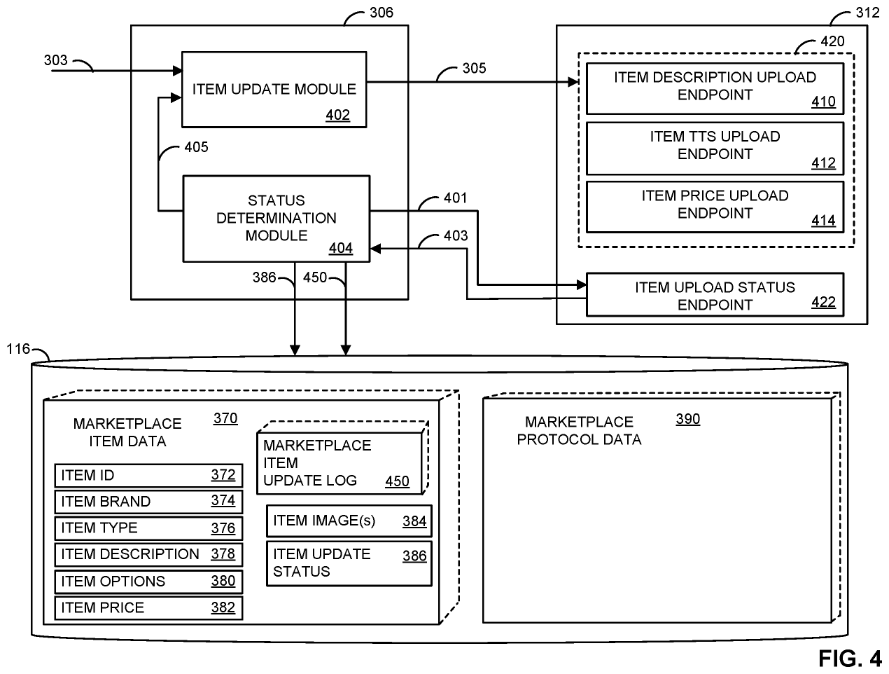

In some examples, marketplace protocol data 390 may indicate that only identified changes are to be provided to update the item description of the item. Marketplace integrator engine 306 may, in this example, generate marketplace update data 307 identifying the differences to the item description. Marketplace integrator engine 306 may then transmit the marketplace update data 307 to the web server 104. In some examples, marketplace integrator engine 306 maintains a status (e.g., successful, not successful, error, etc.) of the item listing update in database 116, as described further below with respect to FIG. 4.

FIG. 4 illustrates further details of marketplace integrator engine 306 providing item delta data 305 to a marketplace API 312, which may be maintained by a web server 104. In this example, marketplace API 312 includes a plurality of item upload endpoints 420. Specifically, in this example, item upload endpoints 420 include item description upload endpoint 410, item time to ship (TTS) upload endpoint 412, and item price upload endpoint 414. Item description upload endpoint 410 allows for the updating of item descriptions of the online marketplace corresponding to the marketplace API 312. Item TTS upload endpoint 412 allows for providing a marketplace with information about an item's total time to ship (e.g., a promised or advertised delivery date). In addition, item price upload endpoint 414 allows for the updating of item prices of the online marketplace. Other endpoints may be supported to update other data related to item listings. In some examples, a single endpoint handles the updating of all data related to item listings.

As an example, if item delta data 305 identifies an update to an item description of an item, marketplace integrator engine 306 may generate marketplace update data 307 in accordance with a protocol expected by item description upload endpoint 410. Marketplace integrator engine 306 may then transmit the marketplace update data 307 to item description upload endpoint 410. For example, marketplace update data 307 may generate an endpoint message identifying the changes and the address of item description upload endpoint 410, and may transmit the endpoint message to the item description upload endpoint 410. Similarly, if item delta data 305 identifies an update to an item price of an item, marketplace integrator engine 306 may generate marketplace update data 307 in accordance with a protocol expected by item price upload endpoint 414. Marketplace integrator engine 306 may then transmit the marketplace update data 307 to item price upload endpoint 414.

In some examples, marketplace integrator engine 306 determines whether the update was successful. For example, marketplace API 312 may include an item upload status endpoint 422 that allows for the requesting and reporting of status, such as status related to the updating of item descriptions of the online marketplace corresponding via the item upload endpoints 420. For example, after providing marketplace update data 307 to an item upload endpoint 420, marketplace integrator engine 306 may generate an item upload status request 401 in accordance with a protocol expected by item upload status endpoint 422. Marketplace integrator engine 306 may transmit the item upload status request 401 to the item upload status endpoint 422 and, in response receive an item upload status response 403. The item upload status response 403 may identify whether marketplace update data 307 was successfully received. For example, the item upload status response 403 may identify that item delta data 305 was successfully received, or whether there was an error, such as a timeout error, an unrecognized request error, or any other error.

In some examples, marketplace integrator engine 306 transmits an item upload status request 401 to the item upload status endpoint 422 after a predetermined amount of time after transmitting the corresponding the item delta data 305. In some examples, if the item upload status response 403 identifies an error, marketplace integrator engine 306 re-transmits marketplace update data 307 to the corresponding item upload endpoint 420. Marketplace integrator engine 306 may store an indication of status received via item upload status responses 403 in item update status 386 of database 116.

In some examples, if marketplace integrator engine 306 does not receive an item upload status response 403 within a predetermined amount of time after transmitting an item upload status request 401, marketplace integrator engine 306 may record a status not reported error. In some examples, marketplace integrator engine 306 may re-transmit the item upload status request 401, such as when receiving an error via an item upload status response 403 or when failing to receive an item upload status response 403 within the predetermined amount of time.

In some examples, marketplace integrator engine 306 logs one or more events within marketplace item update log 450 stored in database 116. For example, marketplace integrator engine 306 may log an indication of any item delta data 305 received, of any item upload status requests 401 transmitted, of any item upload status responses 403 received, and of any determined errors. Item information facilitator computing device 102 may display one or more of marketplace item update log 450 and item update status 386 via user interface 205 of display 206, for example.

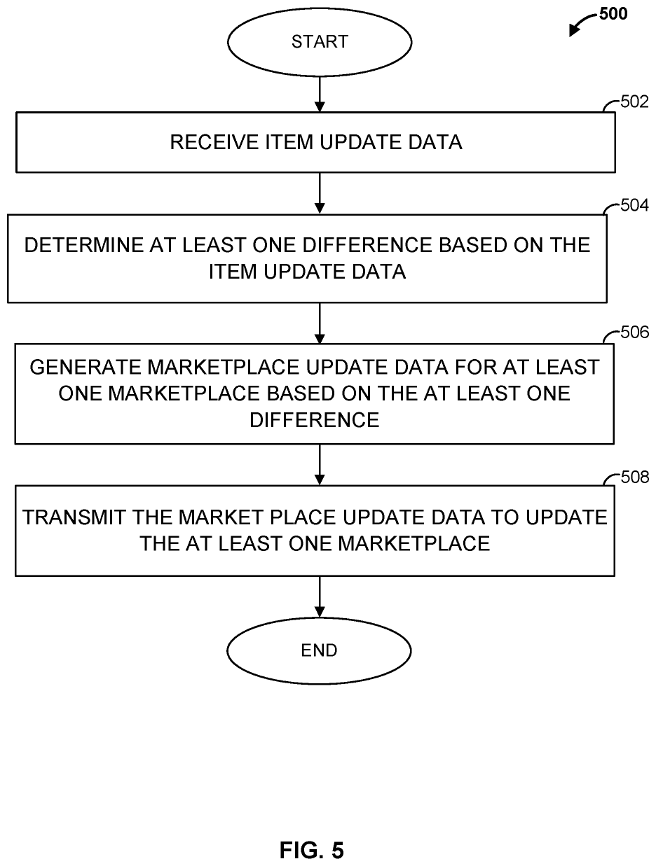

FIG. 5 is a flowchart of an example method 500 that can be carried out by a computing device, such as the item information facilitator computing device 102 of FIG. 1. Beginning at step 502, the computing device may receive item update data, such as item update data 301. At step 504, the computing device may determine at least one difference based on the item update data. For example, the computing device may employ one or more models, such as a neural network or a machine learning model, to generate word embeddings of text received in the item update data. The computing device may compare the word embeddings to word embeddings generated based on a current item listing for the item to determine differences between the word embeddings.

Proceeding to step 506, the computing device may generate marketplace update data, such as marketplace update data 307, for at least one marketplace based on the at least one difference. For example, the computing device may generate a message to transmit to the at least one marketplace in accordance with a protocol for each particular marketplace. At step 508, the computing device may transmit the marketplace update data to each corresponding marketplace. For example, the computing device may transmit the marketplace update data to an endpoint of an API of each corresponding marketplace. The method then ends.

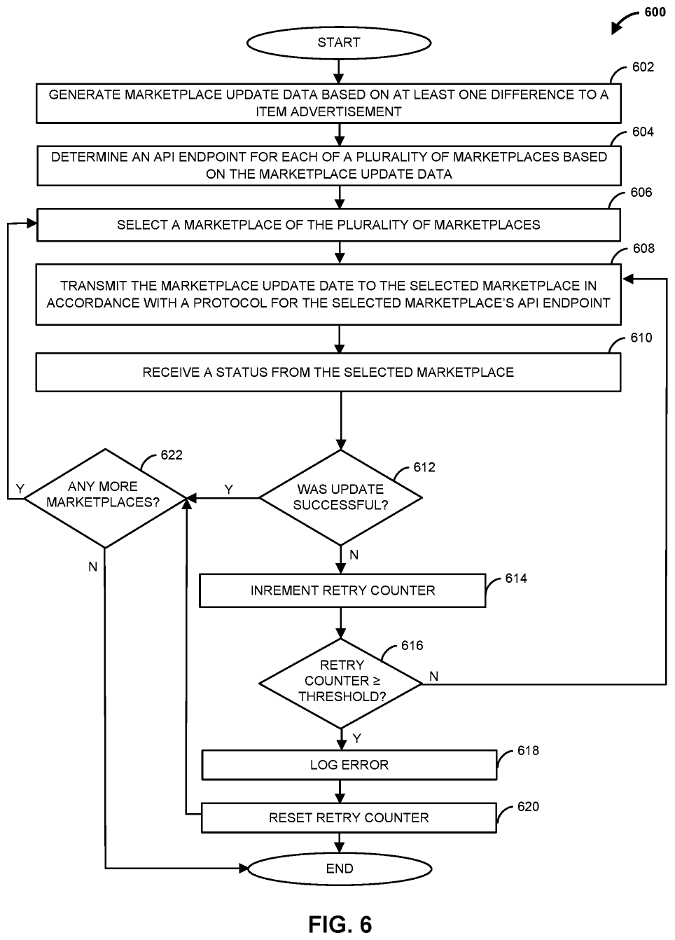

FIG. 6 is a flowchart of an example method 600 that can be carried out by a computing device, such as the item information facilitator computing device 102 of FIG. 1. Beginning at step 602, the computing device generates marketplace update data, such as marketplace update data 307, based on at least one difference to an item advertisement. The item advertisement may be displayed on an online marketplace, and may include, for example, one or more of an item image, an item description, an item price, and item options. In some examples, the marketplace data is generated based on execution of one or more models, such as a neural network or a machine learning model. At step 604, the computing device determines an API endpoint for each of a plurality of marketplaces based on the marketplace update data. For example, the computing device may determine an API endpoint based on the online marketplace being updated, and a portion of item advertisement being updated (e.g., item image, item description, item price, or item options).

Proceeding to step 606, the computing device selects a marketplace of the plurality of marketplaces. The marketplace may be selected randomly in some examples. In other examples, the marketplace may be selected based on an ordered list, such as a priority list, which may be stored in database 116. At step 608, the computing devices transmits the marketplace update data to the selected marketplace in accordance with a protocol for the selected marketplace's API endpoint (as determined during step 604).

At step 610, the computing device receives a status from the selected marketplace. For example, the computing device may receive an item upload status response 403 in response to transmitting an item upload status request 401. The method then proceeds to step 612, where a determination is made as to whether the update (via the transmitted marketplace update data) was successful based on the received status. If the update was successful, the method proceeds to step 622. Otherwise, if the update was not successful (e.g., the received status indicates an error), the method proceeds to step 614.

At step 614, the computing device increments a retry counter. The retry counter may be stored in memory, such as working memory 202. The method then proceeds to step 616, where a determination is made as to whether the retry counter identifies a number of retries that is greater than or equal to a threshold. The threshold may be predetermined and stored in database 116, for example. If the retry counter is less than the threshold, the method proceeds back to step 608, where marketplace update data is re-transmitted to the selected marketplace. Otherwise, if the retry counter is greater than or equal to the threshold, the method proceeds to step 618, where an error is logged. For example, the computing device may log (e.g., write) the error to marketplace item update log 450 stored in database 116. The method then proceeds to step 620, where the retry counter is reset (e.g., reset to 0), and the method proceeds to step 622.

At step 622, a determination is made as to whether any additional marketplaces of the plurality of marketplaces are to be updated with the marketplace update data. If there are any additional marketplaces to be updated, the method proceeds back to step 606, where another marketplace is selected. Otherwise, if there are no additional marketplaces to be updated, the method ends.

Although the methods described above are with reference to the illustrated flowcharts, it will be appreciated that many other ways of performing the acts associated with the methods can be used. For example, the order of some operations may be changed, and some of the operations described may be optional.

In addition, the methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

The foregoing is provided for purposes of illustrating, explaining, and describing embodiments of these disclosures. Modifications and adaptations to these embodiments will be apparent to those skilled in the art and may be made without departing from the scope or spirit of these disclosures.

What is claimed is:

1. A system comprising:
a computing device configured to:
receive item update data identifying at least one attribute of an item;
determine at least one difference to a current item listing of the item based on the item update data;
generate marketplace data for at least one marketplace based on the at least one difference; and
transmit the marketplace data to update the at least one marketplace.

2. The system of claim 1, wherein the computing device is configured to determine the at least one difference by:
determining first word embeddings based on the item update data;
determining second word embeddings based on the current item listing; and
comparing the first word embeddings to the second word embeddings to determine the at least one difference.

3. The system of claim 2, wherein determining the first word embeddings and the second word embeddings is based on executing at least one of a neural network and a machine learning model.

4. The system of claim 1, wherein the computing device transmits the marketplace data to a web server, wherein the computing device is configured to:
transmit a status request to the web server;
receive a status response from the web server in response to the status request; and
determine whether the marketplace data was successfully received by the web server based on the status response.

5. The system of claim 4, wherein the computing device transmits the status request to the web server after a predetermined amount of time from when the marketplace data was transmitted.

6. The system of claim 4, wherein the computing device is configured to:
increment a retry counter;
determine that the status response indicates an error;
determine that the retry counter is below a threshold; and
re-transmit the marketplace update data based on determining that the retry counter is below the threshold.

7. The system of claim 6, wherein the computing device is configured to log the error in a memory device.

8. The system of claim 1, wherein generating the marketplace data for the at least one marketplace comprises:
determining an endpoint for the at least one marketplace based on the at least one difference;
determining a protocol for the endpoint;
generating the marketplace data based on the protocol and the endpoint.

9. The system of claim 8, wherein transmitting the marketplace data comprises transmitting the marketplace data to the endpoint.

10. The system of claim 1, wherein transmitting the marketplace data comprises transmitting the marketplace data to a first web server that hosts a first marketplace and to a second web server that hosts a second marketplace.

11. A method comprising:
receiving item update data identifying at least one attribute of an item;
determining at least one difference to a current item listing of the item based on the item update data;
generating marketplace data for at least one marketplace based on the at least one difference; and
transmitting the marketplace data to update the at least one marketplace.

12. The method of claim 11 wherein determining the at least one difference comprises:
determining first word embeddings based on the item update data;
determining second word embeddings based on the current item listing; and
comparing the first word embeddings to the second word embeddings to determine the at least one difference.

13. The method of claim 12, wherein determining the first word embeddings and the second word embeddings is based on executing at least one of a neural network and a machine learning model.

14. The method of claim 11, wherein transmitting the marketplace data comprises transmitting the marketplace data to a web server, wherein the method further comprises:
transmitting a status request to the web server;
receiving a status response from the web server in response to the status request; and
determining whether the marketplace data was successfully received by the web server based on the status response.

15. The method of claim 14 wherein transmitting the status request comprises transmitting the status request to the web server after a predetermined amount of time from when the marketplace data was transmitted.

16. The method of claim 14 comprising:
increment a retry counter;
determine that the status response indicates an error;
determine that the retry counter is below a threshold; and
re-transmit the marketplace update data based on determining that the retry counter is below the threshold.

17. The method of claim 1 wherein generating the marketplace data for the at least one marketplace comprises:
determining an endpoint for the at least one marketplace based on the at least one difference;
determining a protocol for the endpoint;
generating the marketplace data based on the protocol and the endpoint.

18. The method of claim 11 wherein transmitting the marketplace data comprises transmitting the marketplace data to a first web server that hosts a first marketplace and to a second web server that hosts a second marketplace.

19. A non-transitory computer readable medium having instructions stored thereon, wherein the instructions, when executed by at least one processor, cause a device to perform operations comprising:
receiving item update data identifying at least one attribute of an item;
determining at least one difference to a current item listing of the item based on the item update data;
generating marketplace data for at least one marketplace based on the at least one difference; and
transmitting the marketplace data to update the at least one marketplace.

20. The non-transitory computer readable medium of claim 16 further comprising instructions stored thereon that, when executed by the at least one processor, further cause the device to perform operations comprising:
determining an endpoint for the at least one marketplace based on the at least one difference;
determining a protocol for the endpoint;
generating the marketplace data based on the protocol and the endpoint.
